(19) United States
(12) Patent Application Publication
(10) Pub. No.: US 2016/0195230 A1
(43) Pub. Date: Jul. 7, 2016

(54) LIGHTING SYSTEM, IN PARTICULAR FOR A MOTOR VEHICLE LIGHTING MEMBER, COMPRISING A PRINTED CIRCUIT BOARD IN THE PLANE OF THE LIGHTING DIRECTION

(71) Applicant: RENAULT S.A.S., Boulogne Billancourt (FR)

(72) Inventor: Francois GROSDIDIER, Sermaise (FR)

(73) Assignee: RENAULT S.A.S., Boulogne Billancourt (FR)

(21) Appl. No.: 14/906,185

(22) PCT Filed: Jul. 18, 2014
(86) PCT No.: PCT/FR14/51848

§ 371 Date: Jan. 19, 2016

(30) Foreign Application Priority Data
Jul. 22, 2013 (FR) 1357173

(51) Int. Cl. F21S 8/10

(52) U.S. Cl. CPC F21S 48/115; F21S 48/1241; F21S 48/215; F21S 48/2243; F21S 48/2262; F21S 48/2281

(57) ABSTRACT

A lighting system for an automobile vehicle includes a rigid printed circuit board equipped with light-emitting diodes. The rigid board is disposed parallel to a predetermined lighting direction of the lighting system. The lighting system also includes an optical module to propagate and guide the light beams emitted by the light-emitting diodes such that each light beam exiting from the optical module is substantially parallel to the lighting direction.

The invention relates to a lighting system, notably for an automobile vehicle lighting device, comprising a printed circuit board in the plane of the lighting direction.

Some lighting systems comprise a printed circuit board equipped with light-emitting diodes, commonly called LEDs, electrically connected to the printed circuit. A printed circuit board, often denoted using the acronym PCB, is a support base, in general a board, allowing a set of electronic components to be electrically connected together, with the aim of forming a complex electronic circuit. This board is plane and formed from an assembly of one or more thin layers of copper separated by an insulating material. Such a board can be rigid or flexible. In a lighting device, a printed circuit board, or board, equipped with LEDs, is generally disposed perpendicularly to the desired lighting direction for a good light-emission efficiency, the major part of the light beam being emitted by the diodes in a direction perpendicular to the printed circuit board. However, in the automobile field, and in particular in headlamp applications, such a positioning, perpendicular to the lighting direction, imposes a large size on the headlamp and constraints on the design.

There therefore exists a need for a lighting system allowing the size to be reduced and the design to be varied.

For this purpose, one subject of the invention relates to a lighting system, notably for an automobile vehicle headlamp, comprising a rigid printed circuit board equipped with light-emitting diodes, characterized in that the rigid board is disposed parallel to a predetermined lighting direction of the lighting system and in that the lighting system comprises an optical module configured for propagating and guiding the light beams emitted by the light-emitting diodes such that each light beam exiting from said optical module is parallel or substantially parallel to the lighting direction.

Each light beam, composed of all of the light rays coming from a light-emitting diode, is thus propagated and guided in the desired direction. A light-emitting diode generally emits a plurality of light rays in several directions: the light beam composed of these rays thus generally has a conical shape. In the present application, the direction of a light beam is considered as the direction of the axis of symmetry of the cone bounding the light beam. Thus, the light beam is parallel (or substantially parallel) to a lighting direction, when the axis of symmetry of the cone bounding it is parallel (or substantially parallel) to the lighting direction.

The arrangement according to the invention allows the size of the lighting system to be reduced with respect to a lighting system in which the rigid printed circuit board is oriented perpendicularly to the desired lighting direction. This gain in size can thus allow the weight of a device equipped with such a lighting system to be reduced and such a device to be designed with complex stylistic shapes. Furthermore, the lighting system allows a good lighting quality and notably a uniform illumination to be obtained.

Advantageously and in a non-limiting manner, the lighting system may comprise a single printed circuit board.

Advantageously and in a non-limiting manner, the rigid board may be equipped with light-emitting diodes on each of its faces, an arrangement which allows the emission of the light beams to be distributed over either side of the rigid board.

The positioning of the optical module with respect to the light-emitting diodes may be chosen in order to allow the optical module to capture the major part of the light radiation emitted by the light-emitting diodes. Preferably, the optical module may be positioned in such a manner as to capture from 70 to 100% of the light radiation emitted by the light-emitting diodes, preferably from 80 to 100% of the radiation, or even from 90 to 100% of the radiation. For example, the luminous module may thus be situated at a distance of the order of 0.5 to 5 cm from the light-emitting diodes.

Advantageously and in a non-limiting manner, the optical module may be configured in such a manner as to make the light beams emitted by the light-emitting diodes follow a path formed from a first part perpendicular to the rigid board and from a second part parallel to the rigid board, one free end of the first part being positioned facing light-emitting diodes in such a manner as to capture said light beams, the second part comprising one free end arranged to allow the light beams to exit substantially parallel to the lighting direction. Thus, the light beams enter into the optical module via the free end of the first part and exit from the optical module via the free end of the second part. This “right-angle” configuration offers the advantage of being simple to implement.

In particular, the first and second parts of the optical module can be connected via a part configured for reflecting a light beam coming from the first part in the direction of the second part.

This part may be a simple plane external surface oriented appropriately and forming an optical interface. In the present application, the term “external plane surface forming an optical interface” is understood to mean an external surface which is not covered by a material other than that forming the optical module and which is not in contact with any other material. In other words, this external surface is in contact only with the ambient air. Such an arrangement offers the advantage of not requiring the addition or the integration of a deflector element into the optical module: the reflector element is formed within the optical module, which allows the cost of fabrication of the optical module to be reduced and its fabrication to be facilitated.

The reflection of the light beam is then obtained by virtue of the difference in value between the refractive index of the material composing the optical module, inside of which the light rays to be reflected travel, and the refractive index of the air adjacent to the plane external surface. The position of the external plane surface with respect to the first and second parts, and notably its orientation, may then be determined by Snell's law as a function of these refractive indices, preferably in such a manner as to totally reflect the incident radiation.

Advantageously and in a non-limiting manner, the optical module may be formed from at least one element of a polymer material or be made of glass, preferably translucent or transparent, able to propagate and guide a light beam traveling within its volume, notably a light beam emitted by a light-emitting diode. The material used can be any material capable of guiding a light beam, such as a material of the glass or polymer type, colored or not, for example polycarbonate or poly(methylmethacrylate) (PMMA). The optical module can thus be implemented in a simple manner and its form can be adapted to the device designed to receive the lighting system.

In particular, said at least one element of polymer material comprises at least one surface configured for reflecting a light beam from a direction substantially perpendicular to said rigid board toward a direction substantially parallel to the lighting direction.

This surface may be a surface inclined by an angle of 45° with respect to the direction of the incident light beam, where said surface could be coated with a layer capable of reflecting said incident light beam, for example a metal layer.

When the light-emitting diodes are arranged according to parallel rows on the rigid board, notably on one face or on both faces of the board, one element made of polymer material may be provided for each row of diodes.

The invention is not however limited to one particular arrangement of light-emitting diodes.

Irrespective of the arrangement of the light-emitting diodes, one or more masks may be disposed in such a manner as to partially or totally fill any gap separating the elements of polymer material from the side of the optical module via which the light beams exit, thus allowing a particular shape to be defined, which will be seen by the users. These masks also allow technical components situated behind these masks to be hidden and whose sight from the outside of the lighting system is not desirable.

When several elements of polymer material are provided, they are preferably configured in such a manner as not to come into contact with one another. This allows the guidance of the light beams to be improved.

The invention also relates to an automobile vehicle lighting device equipped with a lighting system according to the invention.

This lighting device may notably be chosen from between a headlamp for the signaling of the vehicle and an interior light designed to be situated inside the passenger compartment. Preferably, the device is a headlamp.

A lighting device usually comprises a housing, one face of which is translucent or transparent for the exit of the light beam. The rigid printed circuit board is then disposed inside the housing and fixed to the latter, the direction of the lighting system being such that the light beams exit via the translucent or transparent face of the housing.

Another subject of the invention relates to an automobile vehicle equipped with at least one lighting system according to the invention.

In particular, said lighting system may equip at least one of the following devices:
an interior light situated inside the passenger compartment of the vehicle,
a signaling light of the vehicle.

This signaling light, front or rear, may notably be chosen from amongst a daytime running light (light that automatically switches on when the vehicle starts to move, also known under the acronym “DRL”), a side-light, a reversing light, a fog light, an indicator light, a stop light or any other signaling light.

The invention is now described with reference to the appended non-limiting drawings, in which:

the single FIGURE is a cross-sectional and a perspective view of a headlamp of a vehicle equipped with a lighting system according to the invention.

“Substantially parallel” is understood to mean a direction forming an angle of, at the most, ±20° or of at the most, ±10° with a particular direction.

The single FIGURE shows a headlamp 1 for the signaling of the vehicle, comprising a housing 3 one face 5 of which is translucent or transparent for the exit of the light beams in a lighting direction L. This face 5 can adopt any plane or more complex form as in the example shown.

This headlamp 1 is equipped with a lighting system 7 which comprises a rigid board 9 with a printed circuit equipped with light-emitting diodes (not shown). This rigid board 9 is disposed inside the housing 3, fixed to the latter by any appropriate means.

According to the invention, the rigid board 9 is disposed parallel to the predetermined lighting direction of the lighting system and the lighting system 7 comprises an optical module 11 configured for propagating and guiding the light beams emitted by the light-emitting diodes such that each light beam exiting from said optical module is substantially parallel to the lighting direction.

In the example shown, the lighting direction of the lighting system 7 coincides with the lighting direction L of the headlamp 1.

The optical module 11 is configured in such a manner as to make each light beam follow a path formed from a first part 11A perpendicular to the rigid board and from a second part 11B parallel to the rigid board, the free end 11C of the first part being positioned facing diodes on the rigid board 9, each light beam exiting from the optical module 11 via the free end 11D of the second part.

The free end 11C of the first part is for example a surface for receiving the light beams emitted by the LEDs, for example a plane surface substantially perpendicular to the light beams.

Similarly, the free end 11D of the second part is for example a surface for emission of the light beams, for example a plane surface.

In the example shown, the optical module 11 is formed from several elements 13A, 13B, 13C, 13D made of a polymer material able to propagate and guide a light beam traveling inside its volume. The rigid board 9 in the example comprising light-emitting diodes on its two faces, two of these elements 13A, 13B are situated on top of the board 9, the other two elements 13C, 13D being situated underneath the board 9. These elements may be symmetrical with respect to the board 9, or otherwise.

In the example, the light-emitting diodes are arranged according to parallel rows on the rigid board 9, on each face of the latter. Each first part 11A of an element 13A, 13B, 13C, 13D thus takes the form of a slab perpendicular to the rigid board 9, each second part. 11B also taking the form of a slab parallel to the lighting direction L. These elements 13A, 13B, 13C, 13D are furthermore dimensioned so as not to come into contact with one another.

In the example, masks 15 are furthermore arranged in such a manner as to fill the gap separating the second parts 11B of the elements 13A, 13B, 13C, 13D. A light beam thus only exits via the end of the optical module 11.

Each element 13A, 13B, 13C, 13D comprises a surface 11E configured for reflecting a light beam between its first part 11A and its second part 11B. In the example, this surface 11E is inclined by an angle of 45° with respect to the direction of the incident light beam, this direction being perpendicular to the rigid board 9 in the example.

In order to improve its reflective properties, the surface 11E may be coated with a reflective metal layer.

The optical module 11 thus arranged allows the propagation and the guidance of the light beams emitted by the light-emitting diodes following the path symbolized by the arrows represented inside the optical module 11 in the example shown.

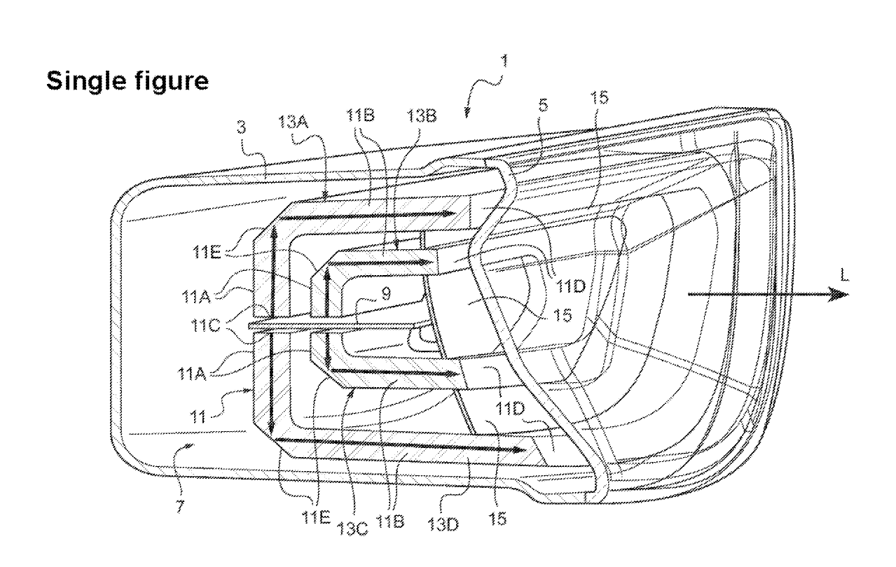

The lighting device described with reference to FIG. 1 is an automobile vehicle headlamp.

The invention is not however at all limited by the type and the form of the lighting device, which may also be an interior or exterior lighting device, for a vehicle or a building.

The lighting system according to the invention indeed offers the advantage of being usable in numerous devices of which it is, in particular, sought to reduce the size and the weight.

1-10. (canceled)

11. A lighting system for an automobile vehicle, comprising:
a rigid printed circuit board equipped with light-emitting diodes, the rigid board being disposed parallel to a predetermined lighting direction of the lighting system; and
an optical module configured to propagate and guide the light beams emitted by the light-emitting diodes such that each light beam exiting from said optical module is substantially parallel to the lighting direction.

12. The lighting system as claimed in claim 11, wherein the rigid board is equipped with the light-emitting diodes on each face of the rigid board.

13. The lighting system as claimed in claim 11, wherein the optical module is configured to make the light beams emitted by the light-emitting diodes follow a path formed from a first part perpendicular to the rigid board and from a second part parallel to the rigid board, a free end of the first part being positioned facing light-emitting diodes to capture said light beams, the second part comprising a free end arranged to allow the light beams to exit substantially parallel to the lighting direction.

14. The lighting system as claimed in claim 13, wherein the first and second parts of the optical module are connected via a part configured to reflect a light beam coming from the first part in a direction of the second part.

15. The lighting system as claimed in claim 11, wherein the optical module is formed from at least one element of polymer material able to propagate and to guide a light beam traveling inside its volume.

16. The lighting system as claimed in claim 15, wherein the polymer material of the optical module is translucent or transparent.

17. The lighting system as claimed in claim 15, wherein said at least one element made of polymer material comprises at least one surface configured to reflect said light beam from a direction substantially perpendicular to said rigid board toward a direction substantially parallel to the lighting direction.

18. The lighting system as claimed in claim 17, wherein said at least one surface is a surface inclined by an angle of 45° with respect to a direction of an incident light beam.

19. The lighting system as claimed in claim 18, wherein said at least one surface is coated with a layer configured to reflect said incident light beam.

20. An automobile vehicle lighting device, comprising:
a lighting system as claimed in claim 11.

21. The lighting device as claimed in claim 20, wherein the lighting device is a headlight of the vehicle.

22. An automobile vehicle, comprising:
at least one lighting system as claimed in claim 11.

23. The automobile vehicle as claimed in claim 22, wherein said lighting system is comprised in at least one of:
an interior light situated inside a passenger compartment of the vehicle, and
a signaling light of the vehicle.
